(19) United States
(12) Patent Application Publication
(10) Pub. No.: US 2026/0246538 A1
(43) Pub. Date: Aug. 20, 2026

(54) Single-Wave Optical Receiver With Improved Sensitivity

(71) Applicants: Peter Avo Andrekson, Orefield, PA (US); Rasmus Larsson, Nol (SE)

(72) Inventors: Peter Avo Andrekson, Orefield, PA (US); Rasmus Larsson, Nol (SE)

(21) Appl. No.: 19/056,900

(22) Filed: Feb. 19, 2025

(51) Int. Cl. H04B 10/61

(52) U.S. Cl. CPC H04B 10/6165

(57) ABSTRACT

An ultralow noise PSA (e.g., <3 dB) is described that utilizes a pair of local, high power pump sources to impart gain to a relatively weak received communication signal using a four-wave mixing (FWM) process within a nonlinear optical component. A feedback loop positioned around the nonlinear optical component is used to generate the pump beams, with a portion of the amplified output supplied as an error signal to a phase locking control circuit within the feedback loop. The phase locking control circuit monitors any phase changes in the received communication signal and adjusts the phase(s) of the pump beams to maintain phase locking (synchronizing the pumps to the communication signal) to achieve high output gain from the PSA.

### TECHNICAL FIELD

This disclosure is directed to the formation of an optical receiver with improved sensitivity and, more particularly, to the implementation of a phase-sensitive (pre)amplifier (PSA) for amplifying weak signals prior to performing data recovery in an associated optical receiver.

### BACKGROUND

Free-space optical communication links are currently under consideration as a replacement for traditional radiofrequency (RF) wireless links over long distances, e.g. satellite-to-satellites, satellite-to-earth, and perhaps deep-space communication links from the moon and beyond. This change of trend is due in large part to the reduced power spread of free space optical signal transmission compared to RF wireless signal transmission. That is, the use of the shorter wavelengths within the optical spectrum lessen the diffraction (spread) of the beam as it propagates through free space. When accounting for finite-sized transmit and receive antennas or telescopes, light-based transmission can thus result in a lower power loss in the link. This is important as the amount of information (in terms of bits per second) that can be sent over a communication link (information capacity) is dictated, in part, by the power collected at the receiver.

The total of the information capacity (in bits/sec) for a given link is obtained when dividing the received power (in energy/sec) by the receiver's sensitivity, which is the minimum required received energy per data bit that the receiver requires for error-free information retrieval. As these free-space links are in demand for high information capacity, it is crucial to maximize the amount of power collected by the receiver. However, since there are practical limits to the amount of power that the transmitter can emit and the size of the receiver's collection area, the receiver's sensitivity is also highly important.

Photon-counting receivers, which have been successfully employed in recent outer space-based communication systems, have shown the best receiver sensitivity to date by using pulse-position modulation formats. For this approach, reaching high sensitivity means allocating the transmitted power into a short time-frame, producing pulsed signals exhibiting both a high peak power and a low average power. To accomplish such a signal and also reach high information capacity, the signal time-frames containing the power must be compressed to an extent that these single-photon detectors are unable to resolve due to their practically limited bandwidth.

Another approach that enables both high information capacity and sensitive reception is that of optical coherent communications, which is widely used in today's high speed fiber network. The receiver of such a coherent optical transmission link is typically made sensitive by using an optical amplifier at the input to the receiver as a pre-amplifier. The noise figure (NF) of this pre-amplifier defines the amount of noise added to the signal during amplification and dictates the receiver sensitivity.

For pre-amplification, erbium doped fiber amplifiers (EDFAs) have commonly been used. However, EDFAs are limited to a minimum NF of 3 dB (or a factor of 2). Better sensitivity can be obtained by using optical phase-sensitive parametric amplifiers which are the only known type of amplifiers proven to have a theoretical NF limit of 0 dB. Phase sensitive amplifiers (PSAs), in contrast to stimulated emission-based amplifiers (like the EDFA), amplify a signal wave by means of nonlinear interaction with several other waves (wave mixing) of different frequencies, among which one or several strong pump waves are present. Noise figures as low as 1 dB have been demonstrated using both three-wave mixing and four-wave mixing PSAs; however, their implementation into practical optical links has been complex, compromising their achievable NF results in comparison to theoretical values.

The complexity associated with the operation of PSAs stems from the need to utilize several optical phase-locked waves, including the signal wave, an idler wave, and one or more pump waves. High fidelity, strong pump wave(s) that are used to exchange power with the signal wave as means of amplification must be created at the receiver in practice. Various arrangements to date have required complex transmitter and/or receiver configurations (compared to a conventional link) which are counter to the requirements of important applications (e.g., a spacecraft) for reasons of weight, power consumption and redundancy.

### SUMMARY OF THE INVENTION

This disclosure is directed to the formation of an optical receiver with improved sensitivity and, more particularly, to the implementation of a phase-sensitive (pre)amplifier (PSA) for use as a component in the optical receiver so as to enable data recovery from relatively low power received signals.

More particularly, the disclosed invention is directed to an ultralow noise PSA (e.g., <3 dB) that utilizes a pair of local, high power pump sources to impart gain to a relatively weak received communication signal using a four-wave mixing (FWM) process within a nonlinear optical component. An associated transmitter is not required to prepare and transmit additional idler waves, since the self-contained PSA creates the pair of pump beams used for amplification. A feedback loop is used in a pump generation component around the nonlinear optical component to maintain phase locking between the pumps and signal, thus ensuring maximum signal amplification.

In one embodiment, a section of highly-nonlinear optical fiber (HNLF) may be used as the nonlinear optical component. In this case, it is preferable to select transmission wavelengths at or near the zero dispersion wavelength of the fiber, with the pump wavelengths being separated on either side of selected transmission wavelength.

In an alternative embodiment, an integrated photonic component may be designed to include the nonlinear optical component; for example, a silicon nitride-based structure that performs the mixing between the signal and the pumps. The integrated photonic embodiment may not exhibit the same transmission wavelength restrictions as HNLFs, but may have additional cost and/or complexity.

The pair of pump beams created by the PSA may be derived from various sources. For example, a pair of conventional pump laser diodes may be included within the PSA. Alternatively, a single laser source may be used with a frequency comb to provide pump beams. In the latter case, the tones exhibit a fixed frequency separation and, therefore, provide an effective way to maintain phase locking with the incoming communication signal.

The ultralow noise PSA of the present invention may be used in a variety of different receiver applications including, but not limited to, free-space optical communication between transmitter and receiver (including space-to-ground and space-to-space links), optical fiber-based systems (including long-haul systems requiring high sensitivity), and transceiver-based sensing systems (such as LIDAR), with return reflections utilized as the input to the inventive PSA.

An exemplary embodiment of the present invention may take the form of a phase-sensitive amplifier (PSA) for imparting gain to an optical signal passing therethrough, the PSA using locally-generated pump beams in combination with a received optical communication signal to perform phase-sensitive amplification. In particular, the PSA comprises a combination of a nonlinear optical element and a pump generation system disposed in a feedback loop around the nonlinear optical element. The nonlinear optical element is responsive to both the received optical signal S_{IN} (operating at a signal wavelength λ_{S}) and locally-created pump beams and uses FWM to amplify the received optical signal S_{IN} and create an amplified output signal S_{OUT}. The pump generation system includes a pump source providing a first pump beam P1 (operating at a first pump wavelength λ_{P1}), and a second pump beam P2 (operating at a second pump wavelength λ_{P2}. A phase locking control circuit is responsive to an out-coupled portion of the amplified output signal and generates therefrom a first control signal for adjusting a frequency (when necessary) of at least one of the first and second pump beams, and a second control signal for adjusting a phase of at least one of the first and second pump beams, the frequency and phase adjustments utilized to maintain phase locking between the received optical signal S_{IN} and the first and second pump beams.

Other and further applications and features of the inventive low noise PSA will become apparent during the course of the following discussion and by reference to the accompanying drawings.

### BRIEF DESCRIPTION OF THE DRAWINGS

Referring now to the drawings, where like numerals represent like parts in several views:

FIG. 1 is a diagram of a known prior art free-space communication link utilizing a PSA as a pre-amplifier at the optical receiver, in this case transmitting pump information along with the data signal across the link from the transmitter to the receiver;

FIG. 2 is a diagram of another type of prior art free-space communication link, where in this case the receiver re-creates the pump beams necessary for phase locking by tapping out a portion of the received signal;

FIG. 3 is a diagram of a free-space communication link, utilizing a phase-sensitive amplifier (PSA) formed in accordance with the principles of the present invention as a pre-amplifier at the receiver;

FIG. 4 is a detailed diagram of an exemplary PSA of the present invention, depicting the use of HNLF as a nonlinear optical element in combination with a pump generation system to maintain phase locking between a received optical signal and locally-created pump beams;

FIG. 5 is a plot of the measured output spectrum from the HNLF nonlinear optical element as shown in FIG. 4;

FIG. 6 is a plot of the measured bit error rate (BER) performance of a receiver using the inventive PSA as shown in FIG. 4, shown in both dBm and photons per bit (PPB);

FIG. 7 illustrates an alternative embodiment of the PSA of FIG. 4, in this case using a silicon nitride-based optical component to perform four-wave mixing instead of using a section of HNLF;

FIG. 8 depicts an embodiment of the present invention where the pump generator utilizes a combination of a single pump source and frequency comb, with a pair of tones filtered from the frequency comb output used to create the pump beams;

FIG. 9 shows an alternative configuration of the pump generator as shown in FIG. 8, where in this case the output from the pump source is phase modulated prior to entering the frequency comb to maintain phase locking with the incoming communication signal; and

FIG. 10 is a diagram of yet another embodiment of the present invention, in this case where the inventive PSA is used as a pre-amplifier component in an optical transceiver configured for metrology applications (e.g., LIDAR).

### DETAILED DESCRIPTION OF THE INVENTION

The present invention relates to the development of an ultralow noise PSA for use as a pre-amplifier in signal reception in applications such as optical communication links, optical metrology (e.g., LIDAR), sensing, as well as other applications where receiver sensitivity is an important design consideration. The invention helps bring the use of ultralow noise PSAs into practical applications, without compromising performance, by reducing the complexity associated with known implementations, and by circumventing any losses associated with prior art arrangements requiring tapping a portion of the received signal prior to amplification (as required for the three-wave mixing case discussed below), or transmission of a transmitter-generated pump reference (as used in the prior art four-wave mixing implementation discussed below). In this new implementation, an alternative four-wave mixing configuration is proposed, based on a single, degenerate signal, and a pair of pump beams created at the PSA.

In order to appreciate the teachings of the present invention and the improvement in performance (particularly in terms of receiver sensitivity), a sample of different prior art optical receivers using PSAs will be briefly described.

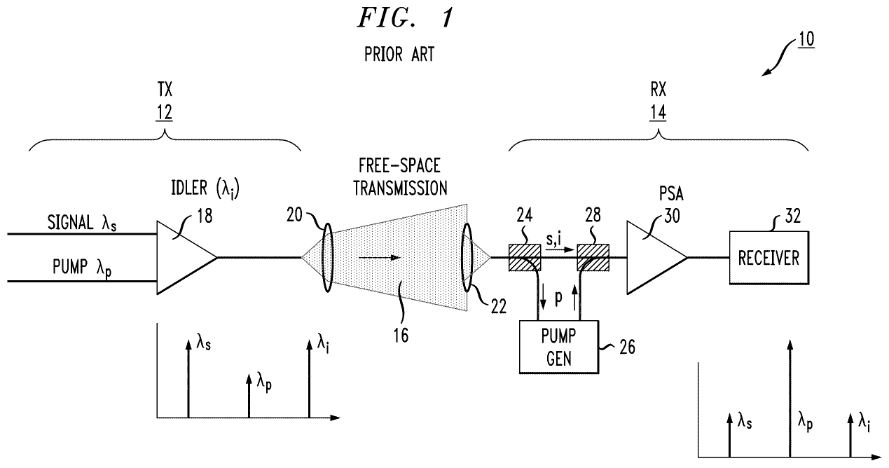

FIG. 1 illustrates an example prior art optical communication system 10 utilizing a PSA at the receiver input to improve the sensitivity of the receiver. The illustrated example system 10 includes a transmitter assembly 12 and a receiver assembly 14, utilizing a free-space transmission path 16 between the two. Transmitter assembly 12 is responsive to an input data signal to create an optical communication signal S operating at a wavelength λₛ. Transmitter 12 also includes a pump source (not shown) for providing a pump beam P operating at a selected wavelength λₚ. A signal processing element 18 is included in transmitter assembly 12 and used to create a conjugate idler wave from the combination of the signal and the pump, the idler operating at a related wavelength λᵢ. Signal processing element 18 includes a nonlinear optical component that performs four-wave mixing of the information signal and the pump to generate an idler signal at wavelength λᵢ. The idler signal is a conjugate copy of the information signal, and propagates at a frequency which is double the frequency of the pump minus the signal frequency (i.e., vᵢ=2vₚ−vₛ). The conjugate is required for phase sensitive signal amplification via four-wave mixing at receiver assembly 14. These three waves are combined and directed through an output lens 20 to be launched as a free-space signal along transmission path 16 to receiver assembly 14.

At receiver assembly 14, the captured portion of the free-space beam is focused via an included lens 22 and directed into the receiver signal path. The pump-carrier reference is removed from this path via a filter (WDM) 24 and then applied as an input to a pump generation component 26. As known in the art, generation component 26 functions to apply the appropriate pump phase to the receiver-created pump. The pump is then recombined in a WDM 28 with the signal and idler for presentation as the input to PSA 30, after which the amplified signal is processed to recover the transmitted data.

The described implementations of idler generator 18 and PSA 30 necessitate the use of rather complex configurations for both the transmitter and receiver (compared to a conventional link). The required complexity is not considered to be viable in a variety of applications, such as to put onboard a spacecraft for reasons of weight, power-consumption and redundancy. The transmission of a pump reference also demands extra power which could otherwise have been assigned to the signal, such as for improved information capacity.

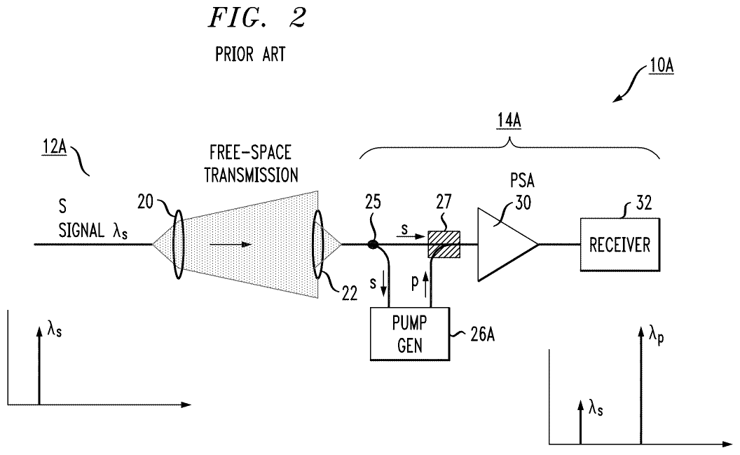

A simplification of the prior art PSA implementation as shown in FIG. 1 is illustrated in prior art FIG. 2, which is defined as optical communication system 10A. In this configuration, the requisite pump beam is created within receiver assembly 14A, allowing for transmitter assembly 12A to be simple and function only to launch the free-space communication signal S, operating at λₛ. While avoiding the need for idler and pump generation in transmitter assembly 12A, the PSA as shown in FIG. 2 requires that a part of the received signal be tapped out prior to amplification (via an included power splitter 25), and thereafter used as a phase reference to feed a pump generation system 26A. The need to use a portion of the received signal before pre-amplification constitutes an additional power loss which thus limits the potential information capacity of the link. The pump output from pump generation system 26A is then combined with the received signal within a WDM 27 and provided as an input to PSA 30.

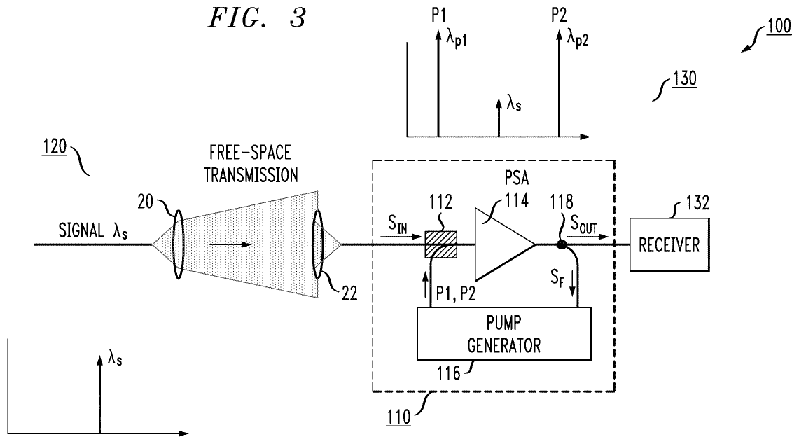

FIG. 3 illustrates a free-space optical link 100 formed in accordance with the principles of the present invention that overcomes the limitations of these and other prior art PSA configurations. More particularly, the present invention discloses an arrangement for an ultralow noise PSA 110 (i.e., NF less than 3 dB). PSA 110 is shown as an “in-line” arrangement in that the assembly comprises a single input (the received optical communication signal) and generates a single output (the amplified optical communication signal), where pump creation and phase-locking is provided in a feedback loop surrounding the nonlinear FWM element.

The proposed implementation offers significant simplification of the implementation of PSAs as pre-amplifiers for optical communication links, allowing a simple optical transmitter to be used which could be mounted on a spacecraft to provide high information capacity downlinks to earth where the PSA/receiver could be situated. In particular, the ultralow noise PSA of the present invention circumvents the need to create pump and idler beams in the transmitter (as in the prior art arrangement of FIG. 1), or the need for signal-tapping at the receiver prior to amplification (as in the prior art arrangement of FIG. 2). As will be discussed in detail below, the use of a single, degenerate signal in combination with a pair of receiver-located pumps results in the provision of the first known single-wave and loss-free practical ultralow noise PSA-based preamplifier, which has the potential to reach 0 dB NF and the best possible sensitivity for any coherent modulation format.

The particular embodiment of FIG. 3 depicts the utilization of PSA 110 in free-space optical link 100, where a conventional transmitter 120 can be used to generate a single data-modulated signal S for transmission at a defined signal wavelength λₛ. At a receiver assembly 130, two receiver-side pumps P1 and P2 (operating at selected wavelengths Δ_{P1} and λ_{P2}, respectively) are created within a pump generator 116. Pumps P1, P2 are thereafter combined in WDM 112 with received signal S_{IN}, with all three beams (two pumps and one signal) applied as an input to a nonlinear optical component 114, which amplifies signal S_{IN} via four-wave mixing with pumps P1, P2 to create amplified output signal S_{OUT}.

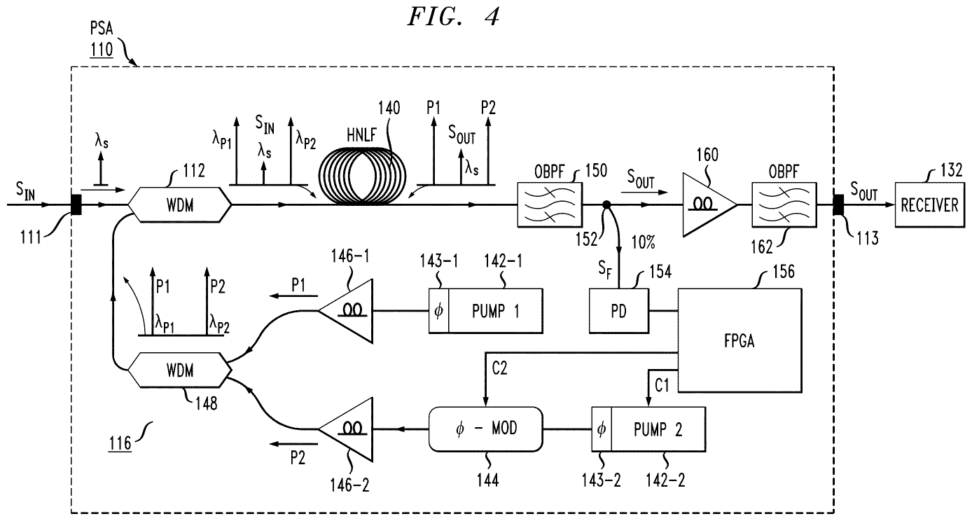

The relative phase between the beams (signal and pumps) determines the direction of power transfer. Therefore, power transfer from pumps P1 and P2 to signal S_{IN}, as well as maintaining a NF<3 dB, may only be achieved when the pumps and the signal are phase locked. The phase locking is accomplished within pump generation system 116, using feedback with frequency and phase control applied to one (or both) of the two pump waves. As shown, a portion (S_{F}) of amplified output signal S_{OUT} is directed into pump generation system 116 by an optical power splitter 118 and used as the feedback information for maintaining phase locking, as will be discussed in detail below in association with FIG. 4. The remainder of amplified output signal S_{OUT} from PSA 110 is thereafter applied as an input to receiver element 132 for data recovery.

The degenerate signal four-wave mixing configuration as shown in FIG. 3 makes PSA 110 compatible with single-quadrature modulation signals. It is to be understood that PSA 110 may be used to receive other, arbitrary modulation via sub-carrier modulation of the signal (which does not complicate the transmitter hardware-wise).

FIG. 4 illustrates in detail an exemplary embodiment of ultralow noise PSA 110 formed in accordance with the principles of the present invention. The example in-line configuration of PSA 110 is depicted as having the captured portion of the transmitted free-space signal S_{IN} coupled into PSA 110 at an input port 111, with the amplified output signal S_{OUT} exiting PSA 110 at an output port 113.

In this example, nonlinear four-wave mixing element 114 comprises a section of highly nonlinear optical fiber (HNLF) 140. Pump generator 116 is shown in this example as comprising a pair of laser diode pump sources 142-1, 142-2 operating at selected pump wavelengths λ_{P1} and λ_{P2} known to be compatible with imparting gain to received signal S_{IN}. A phase correction element 144 is included in PSA 110 and used to adjust the phase of the pump beams, as necessary, to maintain this phase locking with communication signal S_{IN}.

To obtain high PSA gain, the pump inputs to HNLF 140 need to be relatively high-power devices, which then makes the amplification process susceptible to stimulated Brillouin scattering (SBS). The presence of SBS limits the achievable gain and, as a result, the effective NF of PSA 110. Methods to suppress SBS include the use of strained HNLF or distributed isolators positioned around the signal path within pump generator 116. In this particular example, SBS is suppressed by using pump phase modulation, which functions to redistribute the pump power outside of the SBS bandwidth of about 50 MHz. A pair of phase modulators 143-1, 143-2 is disposed at the outputs of pumps 142-1, 142-2, respectively, and used for this purpose. In particular, the pumps are counter-phase modulated using three sinusoidal tones. The need for phase-sensitive operation (for locking between the pumps and the signal) adds the requirement of perfect counter-phase modulation between the pumps, ensuring a constant input phase relation between the pumps and the signal and maximizing the PSA gain.

Continuing with the description of pump generator 116, the SBS-suppressed pump beams are subsequently amplified to enable the high PSA gain result, with pump P1 (operating at the lower pump wavelength λ_{P1}) passing through a C-band EDFA 146-1, and pump P2 (operating at the higher pump wavelength λ_{P2}) passing through an L-band EDFA 146-2. The amplified pump beams P1, P2 are then combined in a WDM 148. In one example, the combination of P1 and P2 exhibited a total pump power of 30.1 dBm (27.1 dBm per pump). The combined pumps and received signal S_{IN} are shown as applied as individual inputs to PSA WDM 112. This set of three lightwaves is shown in FIG. 4 as applied as an input to HNLF 140, where the FWM process within HNLF 140 is used to create an amplified version of the input signal (designated as S_{OUT}).

An optical tap may be placed at the output of HNLF 140 and used to direct a small percentage of the amplified signal (e.g., 1%) to an external optical signal analyzer (OSA), not shown, for analysis of the created spectrum. An optical bandpass filter (OBPF) 150 is shown as receiving the output from HNLF 140 and used to remove any residual pump energy from the output signal path, as well as any out-of-band (signal band) noise; thus, only amplified signal S_{OUT} is shown as the output from OBPF 150. The filtered, amplified signal S_{OUT} is then passed through a power splitter 152, which directs a majority (e.g., 90%) of the signal through an EDFA amplifier 160 and subsequent OBPF 162 before exiting PSA 110 and being directed into receiver 132. The remaining portion (e.g., 10%) of amplified signal, denoted S_{F}, is directed into pump generator 116 as the feedback used to maintain phase locking between the received signal and the generated pair of pump beams.

Feedback signal S_{F} is passed through a photodetector 154, with the electrical output then applied as an input to a phase-locking control circuit 156, in this case illustrated as a field-programmable gate array (FPGA). Various types of processors and/or power detection units may be used to implement this control circuit, with the descriptor “FPGA” used at times hereafter for the sake of convenience. FPGA 156 is used in a known manner to create an electrical error signal that is used in this particular example to create a pair of output control signals, a first control signal C1 to adjust the frequency of second pump beam P₂, and a second control signal C2 to adjust the phase added by phase correction element 144 (in this embodiment). The combination of photodetector 154 and FPGA 156 thus maintains PSA 110 in the necessary phase-locked condition. It is to be understood that the feedback may instead be used to control the frequency of first pump beam P₁, or even a combination of both pump beams.

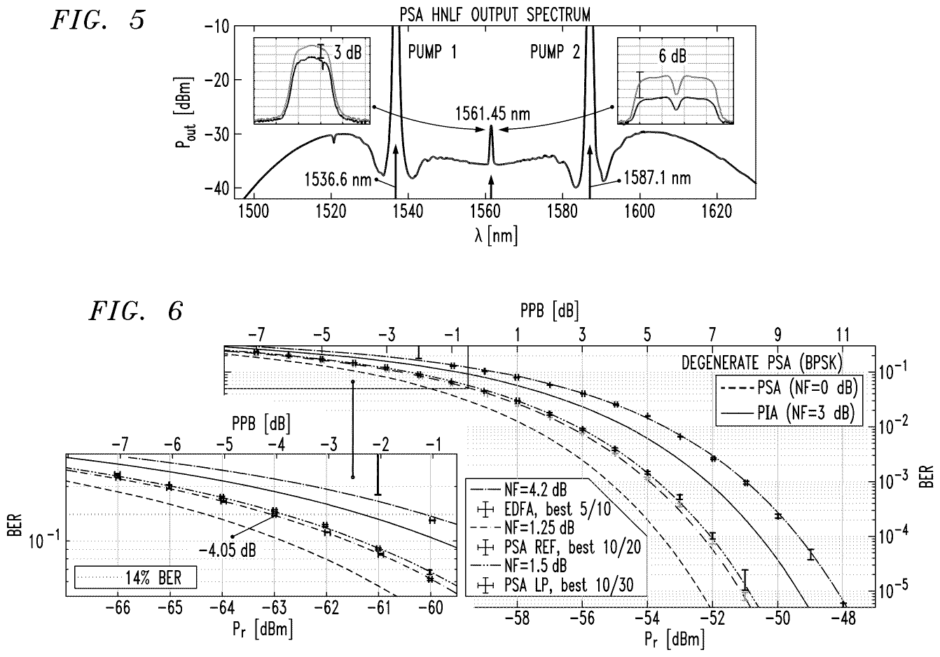

FIG. 5 is a plot of the output spectrum from HNLF 140, which includes both residual pump beams P1, P2, and amplified signal S_{OUT}. The insets illustrate the difference between “unlocked” and “phase locked” operation of FWM within HNLF 140, useful in understanding the phase-sensitive gain of the PSA.

FIG. 6 is a plot of bit error rate (BER) performance of a receiver using PSA 110 as shown in FIG. 4, shown in both dBm and photons per bit (PPB). Included for comparison is data associated with the use of an EDFA-based preamplifier (NF_{EDFA}=4.2±0.1 dB) as well as theoretical curves exhibiting different NF values.

In order to reach a low NF for PSA 110, the FWM processes that incorporate both the signal and higher-order idlers need to be suppressed. This is to minimize excess vacuum noise transfer from these idlers to signal S, while simultaneously promoting the desired FWM process between pumps P1, P2 and S. To achieve this, both signal and pump wavelengths need to be carefully chosen, based on the FWM phase matching conditions, given the dispersion profile of HNLF 140, its nonlinear constant, as well as the pump power used. Study has found that an optimal wavelength configuration is based upon a signal wavelength λₛ which is at (or slightly on the short-wavelength side of) the zero-dispersion wavelength (λ_{ZDW}) of HNLF 140. Additionally, the optimum pump wavelengths should be selected to have a relatively wide separation (e.g., on the order of tens of nm) from the signal wavelength. One example group of wavelengths has been defined as using a signal wavelength λₛ=1561.45 nm (slightly less than the (λ_{ZDW} value of 1561.7 nm), with a pump separation of 50.5 nm around λₛ. That is, λ_{P1}=1536.6 nm and λ_{P2}=1587.1 nm.

Said another way, a limitation with the above-described embodiment stems from the necessary close confinement of signal wavelength λₛ with the zero-dispersion wavelength λ_{ZDW} of the HNLF, necessary to achieve a low NF. This restriction on signal wavelength limits the low-noise PSA bandwidth for a given HNLF component. While other HNLFs can be used to accommodate other signal wavelengths, the implementation of FWM-type PSAs on a silicon nitride (SiN) chip-based platform may provide the freedom in dispersion engineering to enable a much wider low-noise bandwidth for the inventive dual-pump, degenerate signal PSA. Advantageously, a chip-based platform also avoids SBS and the pump phase modulation penalty, as well as reduce the effective PSA length and help eliminate the added phase-locking penalty imposed by the 350 m HNLF that dominates the OPLL loop delay in this configuration.

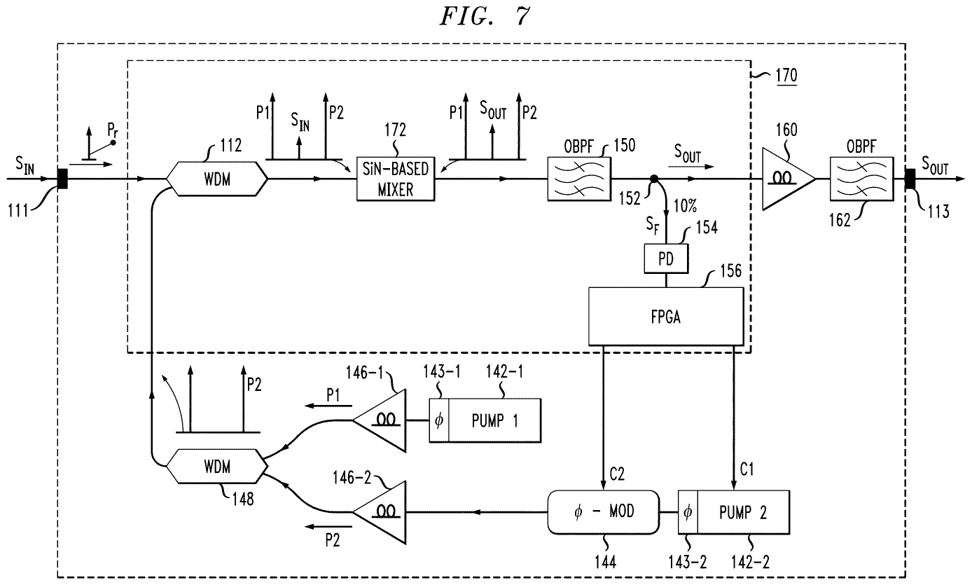

FIG. 7 illustrates an exemplary embodiment of the present invention that utilizes a SiN chip-based nonlinear component in place of a section of HNLF. As shown, an integrated photonics platform 170 is formed to include a silicon-nitride based FWM element 172 that exhibits the necessary nonlinear properties over a wider wavelength range. Various other components of the PSA structure (e.g., WDMs, FPGA, and the like) may also be integrated within or mounted upon integrated photonics platform 170, forming an extremely compact PSA configuration.

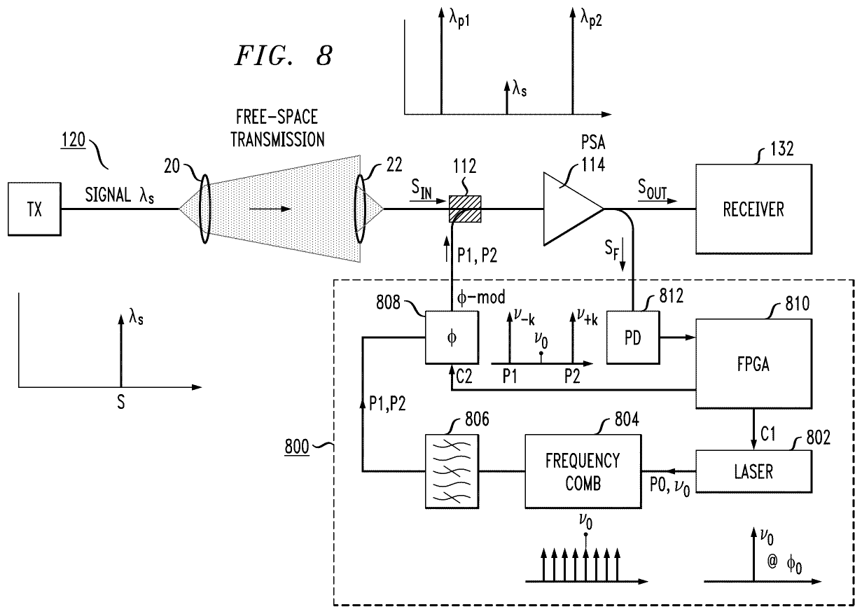

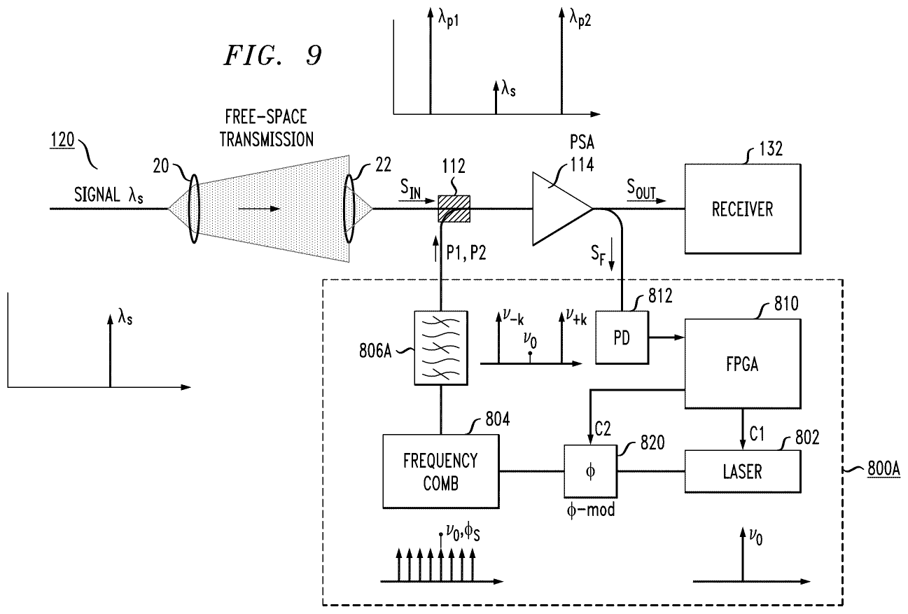

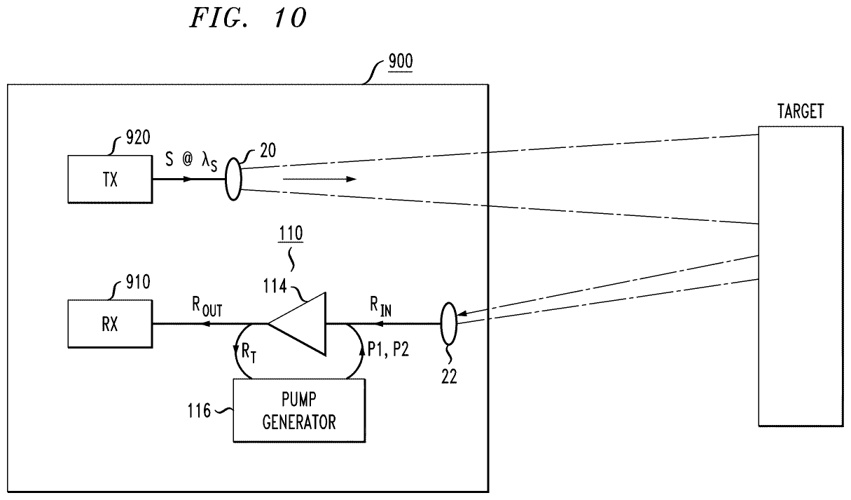

As discussed, one aspect of the present invention is the creation (and maintenance) of a pair of pumps that are phase locked to the received signal (that is, remain synchronous with the received signal). It is proposed in the configurations shown below in FIGS. 8 and 9 to utilize a frequency comb in combination with a laser source to provide a pair of pumps that exhibit a known, fixed frequency separation.

FIG. 8 illustrates an exemplary transmission system implementing a frequency comb-based pump generator 800 (as compared to the use of discrete laser pump sources in pump generator 116, as described above). The basic receiver components remain the same as discussed above; that is, lens 22 for focusing a captured portion of the free space communication signal S_{IN}, WDM 112 for directing received communication signal S_{IN} into PSA 114, and thereafter directing an amplified version of received communication signal S_{OUT} into receiver 132.

Referring now to pump generator 800 of FIG. 8, a laser source 802 is shown as one element used to provide the pump beams. Laser source 802 is used to provide an initial pump output P0 having a known phase φₒ and frequency v₀. A frequency comb 804 is disposed along the output path from laser source 802 and functions in a manner known in the art to produce multiple tones of P0 at constant frequency spacings above and below the laser's defined frequency v₀. Frequency comb 804 may take the form of an electro-optic or micro-ring device, a bulk optic device, or a fiber-based solution. A filter 806 is positioned at the output of frequency comb 804 and is configured to pass only a selected pair of tones (i.e., pumps) that satisfy the necessary phase-locked condition.

The phase-locked condition can be expressed as:

$$0 = {ϕ}_{p 1} + {ϕ}_{p 2} - 2 {ϕ}_{s} ,$$

where φₚ₁ is defined as the phase of pump P1, φₚ₂ is defined as the phase of pump P2, and φₛ is defined as the phase of received communication signal S_{IN}. By virtue of using frequency comb 804, the created tones inherently exhibit the same phase as pump input P0 and, therefore, φₚ₁=φₚ₂, which is equal to φ0, the controlled phase of laser source 802. Phase locking will thus be maintained for the following:

$$0 = {ϕ}_{0} + {ϕ}_{0} - 2 {ϕ}_{s} , i . e ,$$

$${ϕ}_{0} = {ϕ}_{s}$$

Filter 806 selects a pair of tones that are evenly-spaced around laser frequency v₀, shown in FIG. 8 as v₋ₖ and v₊ₖ, both synchronized at phase φ₀. A phase correction element 808 receives the pair of pump waves P1, P2 from filter 806, with a control signal input from a phase locking control circuit 810 (shown as an FPGA-based device in FIG. 8) used to adjust the phase φ₀ of the pumps as necessary to maintain locking with the phase φₛ of received signal S_{IN}.

The phase information associated with received signal S_{IN} is derived from the out-coupled portion of amplified signal S_{OUT} that is applied as an input to pump generator 800. A photodetector 812 is used to receive out-coupled portion S_{F} from amplified output S_{OUT} created within PSA 114 and provides this signal (in electrical form) as an input to phase locking control circuit 810, in the same manner as discussed above.

FIG. 9 depicts a free space optical communication system similar in form to the configuration of FIG. 8, except in this case a pump generator 800A performs direct modulation on laser source 802, thus imparting a controlled phase φ₀ on pump signal P0 prior to providing the pump as an input to frequency comb 804. A phase correction element 820 receives communication signal phase information φ_{S} from circuit 810, and uses this to adjust the phase φ₀ of the output from laser source 802. In this case, the comb filter is depicted as element 806A, since it needs to also follow the phase modulation. The remaining elements (e.g., circuit 810 and photodetector 812) function in the same manner as discussed above.

It is to be noted that while the present invention pertains specifically to the implementation of an ultralow noise preamplifier for an optical receiver, the receiver itself may be used in systems other than the example free-space link discussed thus far. For example, the free-space propagation and coupling in the above-described embodiments may be replaced by a long-distance fiber link, such as that used in undersea cable systems. Other system configurations, e.g. in metrology using LIDAR could utilize the same free-space coupling unit, where the received signal is a back-scattered portion of the transmitted signal.

FIG. 10 illustrates one example of a LIDAR transceiver 900 using the inventive ultralow noise PSA 110 at the input to its receiver portion 910. Here, a free-space beam emitted by transmit portion 920 is shown as impinging a target T. A portion of the reflected free-space beam (denoted R_{IN}) is focused by lens 22 into PSA 110. Functioning in the same manner as before, PSA 110 enhances (amplifies) the reflected beam and allows for an accurate interpretation of associated metrology. Other system configurations are also possible.

Summarizing the novelty of the invention is the first stand-alone PSA implementation as a ultralow noise pre-amplifier without system complications on either the transmitter or receiver side (compared to conventional links) prior to pre-amplification. The lossless locking, as discussed above in association with FIG. 4 (for example), is implemented in a dual-pump system rather than for a single pump, making single-wave pre-amplification possible using four-wave mixing without excess losses. This is unlike the prior art arrangement of FIG. 2, where tapping of the signal prior to amplification in a three-wave mixing PSA fundamentally limits the achievable NF for the system.

Additional embodiments may be configured to minimize the counter-phase modulation mismatch between the pump sources, as well as the utilization of low-noise lasers at the appropriate pump wavelengths. Minimizing splice losses at the WDMs is helpful as well. The method can be combined with other known methods for improving sensitivity even further including, for example, N-pulse position modulation (PPM) format or the use of a coherent receiver. The concept of pump wave generation and phase-locking uses the amplified signal for error feedback, creating a purely closed-loop system that can employ different kinds of error signal processing (optical or digital) and physical implementations of phase and frequency control.

Moreover, it is to be understood that the ultralow noise PSA of the present invention may also be deployed in a multi-stage amplifier arrangement, with the first stage comprising the ultralow noise PSA (which dominates the overall noise performance), followed by EDFAs or other conventional amplifiers.

What is claimed is:

1. A phase-sensitive amplifier (PSA) for imparting gain to an optical signal passing therethrough, the PSA comprising
a nonlinear optical element responsive to a received communication signal S_{IN} operating at a signal wavelength λ_{S} and a pair of locally-created pump beams, the nonlinear optical element utilizing four-wave mixing (FWM) between the pair of locally-created pump beams and the received communication signal S_{IN} to amplify the received communication signal S_{IN} and create an amplified output signal S_{OUT}; and
a pump generation system disposed in a feedback loop around the nonlinear optical element, the pump generation system including
a pump source for providing the pair of locally-created pump beams, comprising a first pump beam P1 operating at a first pump wavelength λ_{P1} and a second pump beam operating at a second pump wavelength λ_{P2};
a phase locking control circuit responsive to an out-coupled portion of the amplified output signal S_{OUT} and configured to generate therefrom a phase control signal defining a phase difference between the received communication signal S_{IN} and the pair of locally-created pump beams; and
a phase correction element, coupled to the pump source and responsive to the phase control signal for adjusting a phase of one or both of the first and second pump beams so as to maintain phase locking with the received communication signal S_{IN}.

2. The PSA as defined in claim 1, wherein the phase locking control circuit further comprises
a photodetector for receiving the out-coupled portion of the amplified output signal S_{OUT} and converting into an electrical error signal; and
circuitry for determining the phase control signal from the electrical error signal.

3. The PSA of claim 1, wherein the nonlinear optical element comprises a section of highly nonlinear optical fiber (HNLF).

4. The PSA of claim 3, wherein the signal wavelength λ_{S} is selected to be less than the zero-dispersion wavelength λ_{ZDW} of the HNLF.

5. The PSA of claim 1, wherein the nonlinear optical element comprises an integrated photonic component.

6. The PSA of claim 1, wherein the pump source comprises:
a first laser diode for providing the first pump beam P1 operating at the first pump wavelength λ_{P1}; and
a second laser diode for providing the second pump beam operating at a second pump wavelength λ_{P2}.

7. The PSA of claim 6, wherein the pump source further comprises
a first amplifier disposed at the output of the first laser diode; and
a second amplifier disposed at the output of the second laser diode, wherein the first and second amplifier impart additional energy to the first and second pump beams in a manner that creates high levels of communication signal gain within the nonlinear optical element.

8. The PSA of claim 7, wherein the pump source further comprises
a first pump phase modulator disposed between the first amplifier and the first laser diode; and
a second pump phase modulator disposed between the second amplifier and the second laser diode, the first and second pump phase modulators utilized to redistribute pump power away from a bandwidth associated with stimulated Brillouin scattering (SBS).

9. The PSA of claim 1, wherein the pump source comprises
a pump laser diode for providing an initial pump wave with a known frequency v₀ and a known phase φ₀;
a frequency comb disposed to receive the initial pump wave and generate therefrom a plurality of equi-spaced frequency tones, each exhibiting the known phase φ₀; and
an optical filter disposed at the output of the frequency comb for selecting as an output a pair of frequency tones for use as the first and second pump beams, defined at frequencies v₋ₖ and v₋ₖ, k being an integer greater than zero, wherein the phase control element adjusts the known phase φ₀ to be equal to the communication phase φₛ and provide phase locking.

10. The PSA of claim 9, wherein the phase modulator controls the phase of the initial pump wave provided as an output of the pump laser diode.

11. The PSA of claim 9, wherein the phase modulator controls the phase of the pair of frequency tones provided as an output from the optical filter.

12. An optical receiver, comprising:
a pre-amplifier for boosting the gain of a received communication signal, providing an amplified output signal; and
a receiving component responsive to the amplified output signal and recovering a communication signal therefrom, wherein the pre-amplifier comprises a phase-sensitive amplifier (PSA) comprising
a nonlinear optical element responsive to a received optical signal S_{IN} operating at a signal wavelength λₛ and a pair locally-created pump beams, the nonlinear optical element utilizing four-wave mixing (FWM) between the pair of locally-created pump beams and the received optical signal S_{IN} to amplify the received optical signal S_{IN} and create an amplified output signal S_{OUT}; and
a pump generation system disposed in a feedback loop around the nonlinear optical element, the pump generation system including
a pump source for providing the pair of locally-created pump beams, comprising a first pump beam P1 operating at a first pump wavelength λ_{P1} and a second pump beam operating at a second pump wavelength λ_{P2};
a phase locking control circuit responsive to an out-coupled portion of the amplified output signal S_{OUT} and configured to generate therefrom a phase control signal defining a phase difference between the received communication signal S_{IN} and the pair of locally-created pump beams; and
a phase correction element, coupled to the pump source and responsive to the phase control signal for adjusting a phase of one or both of the first and second pump beams so as to maintain phase locking with the received communication signal S_{IN}.

13. The optical receiver as defined in claim 12, wherein the received communication signal comprises a free-space optical transmission.

14. The optical receiver as defined in claim 12, wherein the received communication signal comprises a optical signal propagating along an optical fiber.

15. The optical receiver as defined in claim 12, wherein the optical receiver further comprises one or more additional amplifying stages between the PSA and the receiving component.

16. An optical transceiver for use in metrology applications, comprising:
an optical transmit portion for generating a free-space beacon operating at a signal wavelength λ_{S}; and
an optical receive portion responsive to reflections R_{IN} of the free space beam from a target, the optical receive portion including a phase-sensitive amplifier PSA responsive to the reflections and comprising
a nonlinear optical element responsive to the received beacon reflections R_{IN} operating at the signal wavelength λ_{S} and a pair of locally-created pump beams, the nonlinear optical element utilizing four-wave mixing (FWM) between the locally-created pump beams and the received beacon reflections R_{IN} to amplify the received beacon reflections and create an amplified output version thereof R_{OUT}; and
a pump generation system disposed in a feedback loop around the nonlinear optical element, the pump generation system including
a pump source for providing the pair of locally-created pump beams, comprising a first pump beam P1 operating at a first pump wavelength λ_{P1} and a second pump beam operating at a second pump wavelength λ_{P2};
a phase locking control circuit responsive to an out-coupled portion of the amplified output signal R_{OUT} and configured to generate therefrom a phase control signal defining a phase difference between the received communication signal R_{IN} and the pair of locally-created pump beams; and
a phase control element, coupled to the pump source and responsive to the phase control signal for adjusting a phase of one or both of the first and second pump beams so as to maintain phase locking with the received communication signal R_{IN}.
